(19) United States
(12) Patent Application Publication
(10) Pub. No.: US 2005/0194707 A1
(43) Pub. Date: Sep. 8, 2005

(54) Method for manufacturing pliable sponge

(76) Inventor: Jone Chang, Taipei (TW)

Correspondence Address: BIRCH STEWART KOLASCH & BIRCH, PO BOX 747, FALLS CHURCH, VA, 22040-0747, US

(21) Appl. No.: 10/790,725

(22) Filed: Mar. 3, 2004

(51) Int. Cl. B29C 44/56

(52) U.S. Cl. 264/51; 264/321

(57) ABSTRACT

A method for manufacturing pliable sponges aims to fabricate sponges with a pliable surface tissue similar to that of natural sponge. The method includes steps of: foaming and molding material to form sponge cavities; electrifying a molding device to raise the temperature until reaching the sponge melting temperature; sinking the molding device into the sponge on a random spot on the surface of the sponge; and melting away a portion of the sponge in irregular directions to form larger and irregular crevices. The sponge thus formed has properties similar to natural sponge, can provide snug contact with the human body and generate improved cleaning and massage effects.

### FIELD OF THE INVENTION

The present invention relates to a method for manufacturing pliable sponge and particularly to a method that uses a molding device with high temperature to melt the sponge to form irregular crevices and strip tissues similar to natural sponge.

### BACKGROUND OF THE INVENTION

A common bathing experience is that merely using soap foams or bubbles cannot thoroughly remove dirt from the body, especially aging cuticles on the skin. Bathing tools are used to clean and rejuvenate the skin. The bathing tools that have crevices similar to natural sponge can generate more fine foams so that the detergent is more effective to clean the skin.

Present bathing tools are generally divided into mesh type bath scrubbers and air permeable bath sponges. The bath sponges include coarse and fine pore tissues and are usually fabricated by a foaming process. Although the crevices of the sponge enable the detergent to generate foam so that they may be used to scrub the human body for thorough cleaning, the sponges now on the market are generally formed in a cake style and do not have the desirable pliability. They are not very comfortable to use. Using them to scrub the skin forcefully could result in injury to the skin and muscles. Moreover, conventional sponges generally have flat surfaces that do not match human body very well. As a result, their cleaning effect is not satisfactory.

### SUMMARY OF THE INVENTION

The primary object of the present invention is to provide a method for manufacturing pliable sponge that is similar to natural sponge.

The method according to the invention includes foaming sponge material to form a sponge that has crevices; heating a molding device to the melting temperature of the sponge; and melting a portion of the sponge on random spots of the sponge surface in irregular directions through the molding device to become the sponge similar to the natural sponge. The resulting sponge has a plurality of irregular cavities and forms an uneven surface that is similar to natural sponge. Thereby it can be in contact with user's skin snugly when in use to improve cleaning effect, is more pliable and does not hurt user's skin and muscles when in use.

Another object of the invention is to provide sponge that has increased strength after foaming.

While the sponge, melted by the molding device at random spots in irregular directions, tends to have a decreased strength, the moving path of the molding device is a curve without forming sharp angles; therefore, there is no stress concentration. Moreover, the melted portion connects other portions of the sponge after cooling down. Hence, the sponge may be cut into pieces without becoming too fragile and affecting its service life.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1A is a perspective view of the invention.

FIG. 1B is an enlarged view of FIG. 1A.

FIG. 2 is a schematic view of the invention showing the molding device is heated for melting a portion of sponge.

FIGS. 3A, 3B and 3C are plane views of the invention showing the sponge fabrication process.

FIGS. 4A, 4B and 4C are side views of the invention showing the sponge fabrication process.

FIGS. 5A, 5B and 5C are top views of the invention showing the sponge fabrication process.

FIG. 6 is a plane view of another embodiment of the molding device.

FIG. 7 is a plane view of yet another embodiment of the molding device.

FIG. 8 is the process flow chart of the method of the invention.

### DETAILED DESCRIPTION OF THE INVENTION

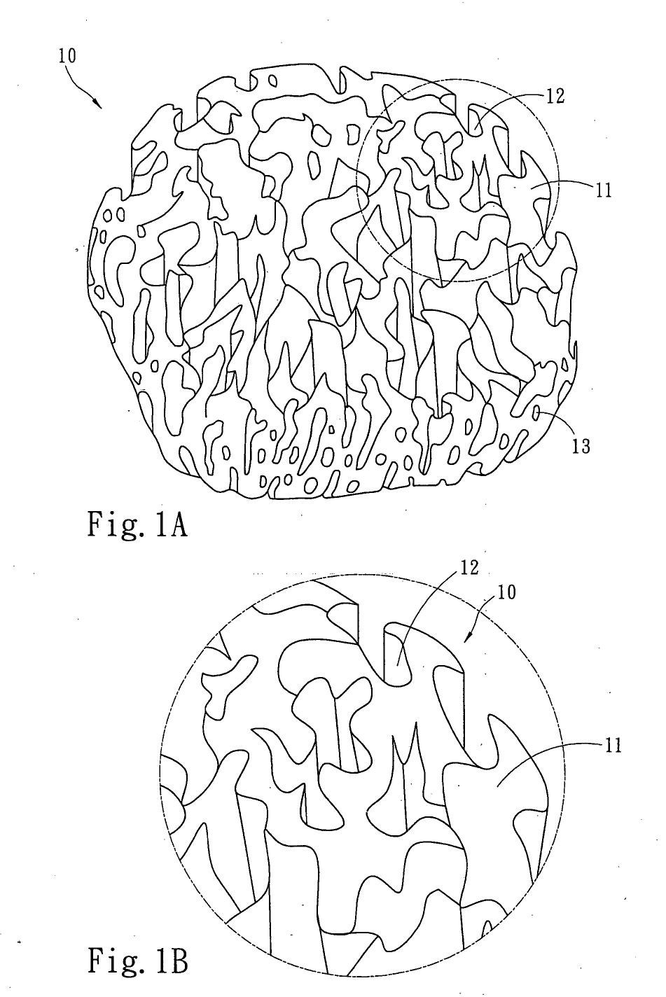

Please referring to FIGS. 1A and 1B, the sponge 10 according to the invention has irregular pliable portions 11 on the surface that are bordered by indented crevices 12. The pliable portions 11 can be used to scrub human skin without dragging the rest of the sponge 10, and can sway at a greater angle during scrubbing to be in contact with the skin more snugly and does not injure the skin or muscles even under excessive force. Moreover, the sponge material forms a plurality of cavities 13 of different sizes on the surface during foaming process. The cavities 13 allow the sponge 10 to have improved water absorption capability and can generate finer foams and bubbles.

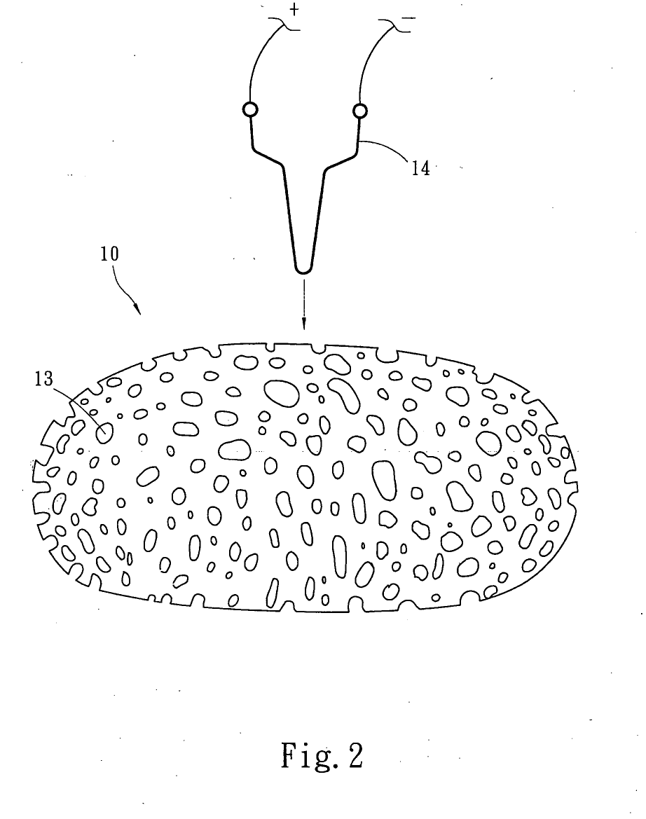

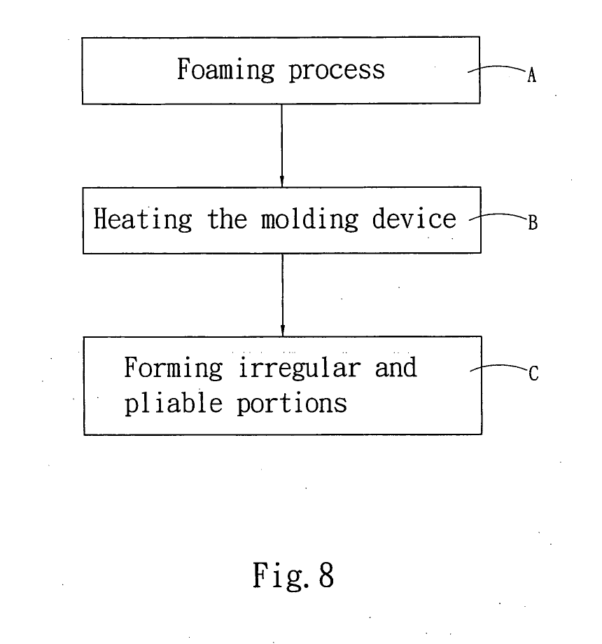

Referring to FIGS. 2 and 8, which is the method of manufacturing the sponge 10. First step A is to foam sponge material to form the sponge 10 that has cavities 13. Second step B is to heat a molding device 14 to the melting temperature of the sponge 10. In one embodiment of the invention, the molding device 14 may be manufactured by nickel and chrome wire that can increase in temperature when connected in an electronic circuit. The third step C is to melt the sponge 10 as desired with the preheated molding device 14. Details of the third step C are described as follows:

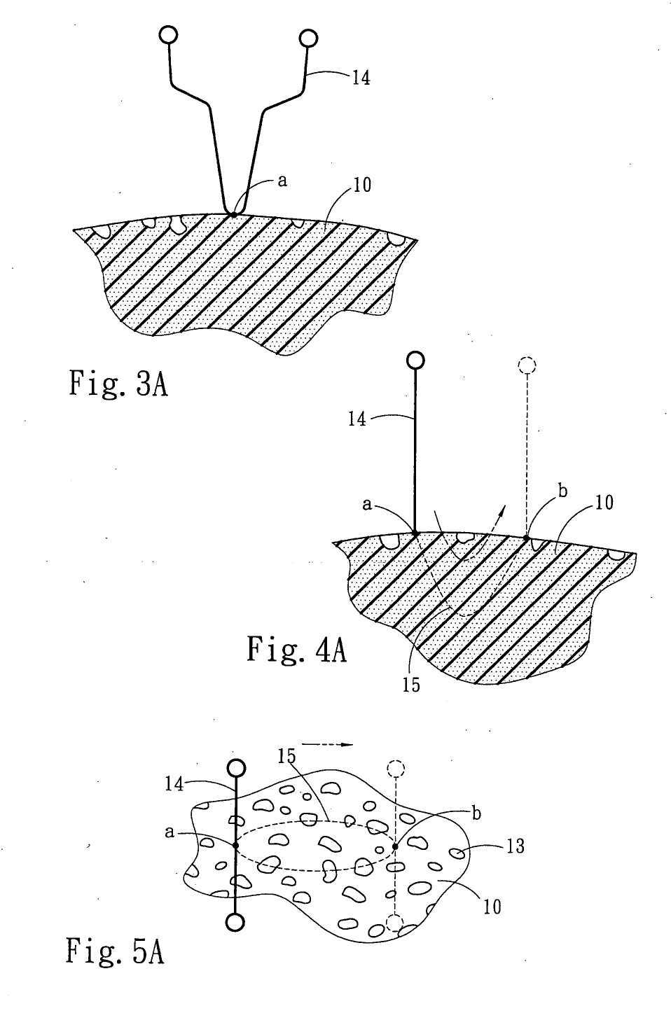

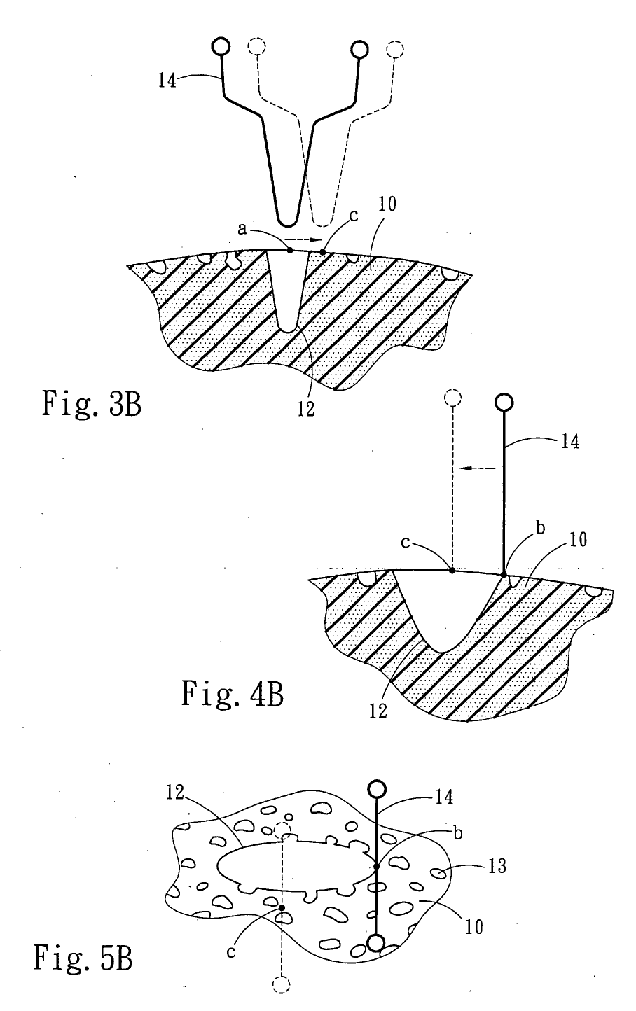

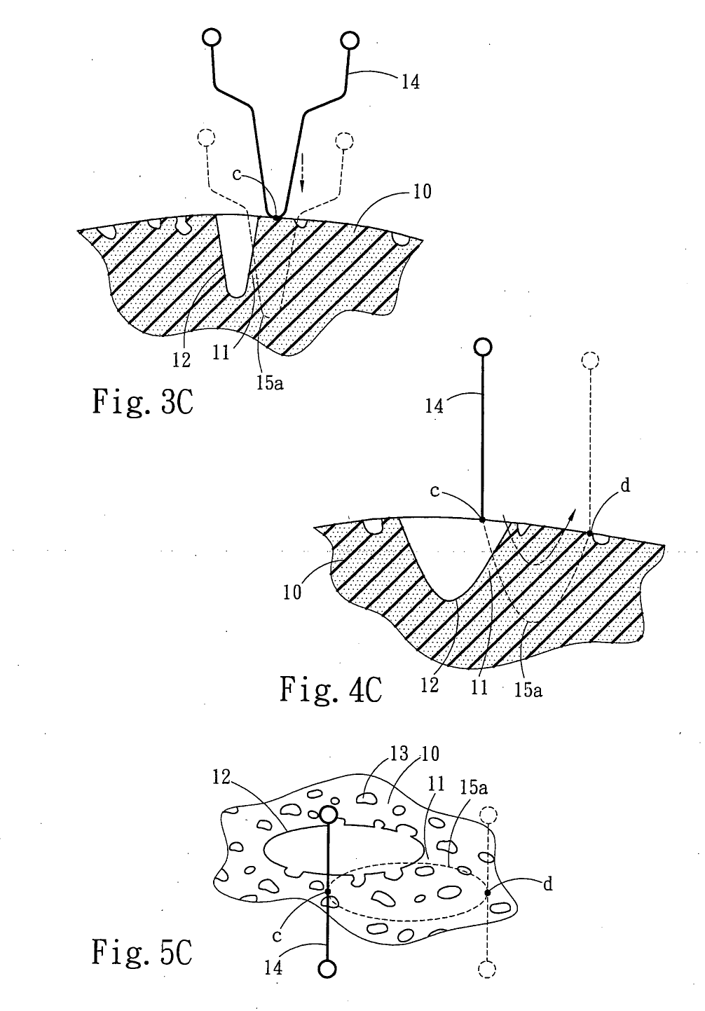

Referring to FIGS. 3A, 4A, 5A and. 8, the third step C is to form the irregular pliable portions 11. This step includes sinking the molding device 14 to a first random spot a on the surface of the sponge 10; melting away a portion of the sponge 10 and dragging the molding device 14 in an irregular direction until a second random spot b is reached; removing the molding device 14 from the sponge 10 at the second random spot b to form a first crevice 12 on the sponge 10. A curved moving path 15 is formed between the spot a and spot b, and the bottom of the first crevice 12 is formed in a curved fashion. Thereby the strength of the sponge 10 may increase.

Referring to FIGS. 3B, 4B and 5B, after the molding device 14 has been removed from the sponge 10, selecting a third random spot c on the sponge 10 and sinking the molding device 14 into the sponge 10 at the third random spot c, and dragging the molding device 14 in irregular directions until reaching a fourth random spot d (referring to FIGS. 3C, 4C and 5C) along a moving path 15a and melting the sponge 10 along the dragging path to form a second crevice 12. The first and the second crevices 12 form a pliable portion 11 in between. Thus, the resulting sponge 10 has crevices 12 of varying depths and irregular pliable portions 11.

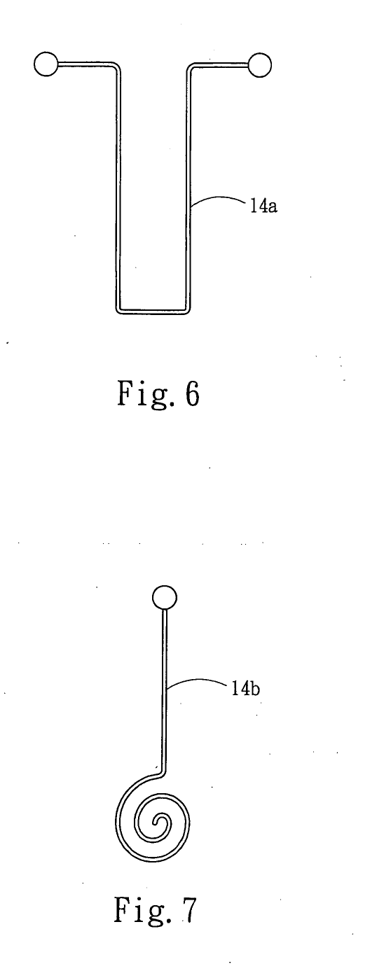

Refer to FIGS. 6 and 7 for other embodiments of the molding device 14. Aside from the curved shape shown in FIG. 2, the molding device 14 may also be formed in a rectangular shape 14a or a helical shape 14b or other geometric shapes. The molding device 14 thus made may be heated to melt the sponge 10 (referring to FIG. 1A) to form the pliable portions 11 on the surface of the sponge 10.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments that do not depart from the spirit and scope of the invention.

1. A method for manufacturing pliable sponge comprising steps of:
A. foaming a sponge material through mold forming to form a sponge containing cavities;
B. heating a molding device until reaching the sponge melting temperature; and
C. sinking the molding device in the sponge at a random spot on the surface thereof and melting a portion of the sponge in irregular directions to form irregular pliable portions which have varying depths.

2. The method of claim 1, wherein after the molding device has been sunk into the sponge, it is dragged from the random spot along an irregular moving path in the sponge to form an indented crevice, the moving path being a curve.

3. The method of claim 1, wherein the molding device is curved.

4. The method of claim 1, wherein the molding device is rectangular.

5. The method of claim 1, wherein the molding device is helical.
